(19) United States
(12) Patent Application Publication
(10) Pub. No.: US 2013/0208096 A1
(43) Pub. Date: Aug. 15, 2013

(54) THREE DIMENSIONAL IMAGE CAPTURING DEVICE WITH DUAL LENSES AND ELECTRONIC APPARATUS HAVING THE SAME

(71) Applicant: Wistron Corporation, (US)

(72) Inventors: Yao-Wei WANG, New Taipei City (TW); Shu-Min Lin, New Taipei City (TW); Ming-Te Lee, New Taipei City (TW); Ting-Yao Cheng, New Taipei City (TW); Wie-Chin Tu, New Taipei City (TW)

(73) Assignee: Wistron Corporation, New Taipei City (TW)

(21) Appl. No.: 13/749,088

(22) Filed: Jan. 24, 2013

(30) Foreign Application Priority Data
Feb. 14, 2012 (TW) 101104671

(51) Int. Cl. H04N 13/02

(52) U.S. Cl. CPC H04N 13/0239
USPC 348/47

(57) ABSTRACT

A three dimensional image capturing device with dual lenses includes a first lens module including a sensor, a second lens module spaced apart from the first lens module by a predetermined distance and including a sensor, and a driving module capable of driving the first and second lens modules to move between first and second positions. The first and second lens modules are arranged in a row. Length directions of images captured by the sensors of the first and second lens modules are parallel to the row of the first and second lens modules in the first position and are perpendicular to the row of the first and second lens modules in the second position.

This application claims priority of Taiwanese Patent Application No. 101104671, filed on Feb. 14, 2012, the disclosure of which is incorporated herein by reference.

### BACKGROUND OF THE INVENTION

1. Field of the Invention

The invention relates to a three dimensional (3D) image capturing device, and more particularly to a three dimensional (3D) image capturing device with dual lenses and an electronic apparatus having the same.

2. Description of the Related Art

A conventional handheld electronic apparatus, such as a digital camera and a mobile phone with camera, has been developed to capture three dimensional digital images. The three dimensional image capturing technique involves arranging two digital photosensitive lens modules horizontally to simulate left and right eyes of a person to form three dimensional images.

Since sensors in conventional digital photosensitive lens modules are arranged to simulate the vision of human eyes with a width larger than its height, the captured images thereof are limited to exhibit the shape of a rectangle. When two lens modules of an existing conventional electronic apparatus that is capable of capturing digital three dimensional images are arranged side by side in a horizontal direction, length directions of images captured by the sensors are consistent with the arrangement of the two lens modules. The reason why the captured images can be displayed on a rectangular display screen is that the length direction of the display screen is also consistent with the arrangement of the two lens modules. In this way, when the handheld electronic apparatus captures an image, the display screen can directly show the images captured by the two lens modules.

However, when it is desired to capture an image of a thin and tall object, the existing conventional electronic apparatus cannot capture a complete three dimensional image of the object. For example, as shown in FIG. 1, to shoot a tree that is thin and tall using an existing conventional electronic apparatus 9 which is oriented such that two lens modules 91 thereof are arranged horizontally in a row, a laterally superimposed three dimensional horizontal image may be captured. Because the horizontal image has a width larger than its height, the electronic apparatus 9 can only capture a part rather than a whole image of the tree. As shown in FIG. 2, if the orientation of the electronic apparatus 9 is changed such that the two lens modules 91 are arranged vertically in a row, images captured by the two lens modules 91 are vertical images each having a height larger than its width. Hence, both lens modules 91 can respectively capture a whole image of the tree. However, the images are vertically superimposed, and cannot produce the three dimensional effect of two human eyes.

Therefore, how to present a complete three dimensional image when capturing a thin, tall object is an issue that remains to be solved.

### SUMMARY OF THE INVENTION

Therefore, an object of the present invention is to provide a three dimensional image capturing device with rotatable dual lenses to facilitate capturing images of objects with different aspect ratios.

Another object of the present invention is to provide an electronic apparatus having a three dimensional image capturing device with rotatable dual lenses.

According to one aspect of this invention, a three dimensional image capturing device with dual lenses comprises a first lens module including a sensor, a second lens module spaced apart from the first lens module by a predetermined distance and including a sensor, and a driving module capable of driving the first and second lens modules to move between a first position and a second position. The first and second lens modules are arranged in a row. In the first position, length directions of images captured by the sensors of the first and second lens modules are parallel to the row of the first and second lens modules. In the second position, length directions of images captured by the sensors of the first and second lens modules are perpendicular to the row of the first and second lens modules.

According to another aspect of this invention, an electronic apparatus capable of capturing three dimensional images comprises a housing, a display screen mounted to the housing, and a three dimensional image capturing device mounted to the housing and electrically connected to the display screen. The three dimensional image capturing device includes a first lens module including a sensor, a second lens module spaced apart from the first lens module by a predetermined distance and including a sensor, and a driving module capable of driving the first and second lens modules to move between a first position and a second position. The first and second lens modules are arranged in a row. In the first position, length directions of images captured by the sensors of the first and second lens modules are parallel to the row of the first and second lens modules. In the second position, length directions of images captured by the sensors of the first and second lens modules are perpendicular to the row of the first and second lens modules.

Preferably, the driving module includes a first lens carrier defining a first axis, a second lens carrier defining a second axis, and a main carrier having a main axis. The first lens carrier and the first lens module are connected to each other and rotate together about the first axis. The second lens carrier and the second lens module are connected to each other and rotate together about the second axis. The first axis, the main axis and the second axis are parallel to each other and are arranged side by side at an interval along a straight line. The main axis is located between the first and second axes. The first and second lens carriers are disposed on the main carrier and rotate about the main axis along with the main carrier. Because the main carrier and the first and second lens carrier rotate synchronously, the length directions of images captured by the sensors of the first and second lens modules in the first position are parallel to the row of the first and second lens modules and are parallel to a length direction of the display screen, and are perpendicular to the row of the first and second lens modules in the second position and are parallel to the length direction of the display screen.

The aforesaid row of the first and second lens modules refers to the arrangement of the first and second lens carriers along the straight line. The length direction described in the specification refers to the length of a rectangle. For example, the length direction of the captured image is the length of the rectangular image. The length direction of the display screen is the length of the rectangular display screen.

Preferably, the main carrier includes a fixed disk and a rotatable disk. The rotatable disk is connected movably to the fixed disk and is rotatable about the main axis relative to the fixed disk. The first and second lens carriers are disposed on the rotatable disk. Further, the main carrier further includes a gear shaft disposed on the fixed disk. The gear shaft has an axis coinciding with the main axis. The rotatable disk is provided with a through hole. The gear shaft extends through the through hole to protrude out of the rotatable disk. Moreover, the rotatable disk further has two shafts respectively located at two opposite sides of the through hole. Axes of the two shafts respectively coincide with the first and second axes. The first and second lens carriers are respectively a gear, are respectively and rotatably mounted on the shafts, and are meshed with the gear shaft, so that the first and second lens carriers are rotatable relative to the gear shaft. Each of the shafts has a central aperture extending along an axis thereof. The fixed disk further has two arc-shaped through slots respectively corresponding to traces of movement of the central apertures of the shafts when rotating along with the rotatable disk.

Preferably, the main carrier further includes a limiting mechanism disposed on the fixed disk and the rotatable disk to limit an angle of rotation of the rotatable disk. A specific example is the fixed disk has a first surrounding wall and the rotatable disk has a second surrounding wall cooperating with the first surrounding wall. The limiting mechanism includes a limiting notch formed in the first surrounding wall and a limiting protrusion connected to the second surrounding wall. The limiting protrusion is movable within the limiting notch. Another specific example is the limiting mechanism includes two first magnetic elements disposed on the fixed disk and a second magnetic element disposed on the rotatable disk. The two first magnetic elements respectively define two endpoints of a range of rotation of the rotatable disk, and are located in a trace of movement of the second magnetic element along with the rotatable disk, so that the second magnetic element is magnetically drawn to one of the first magnetic elements.

Preferably, the electronic apparatus further comprises a cover covered on the rotatable disk and rotating along with the same. The cover has two through holes respectively corresponding to the first and second lens modules.

The advantage of the present invention resides in that because the driving module can drive the first lens module and the second lens module to rotate to the first position to form a horizontal three dimensional image or to the second position to form a vertical three dimensional image, the user can conveniently capture images of objects with different aspect ratios.

### BRIEF DESCRIPTION OF THE DRAWINGS

Other features and advantages of the present invention will become apparent in the following detailed description of the embodiments with reference to the accompanying drawings, of which:

FIG. 1 is a schematic view illustrating a use state of a conventional electronic apparatus capable of capturing three dimensional images;

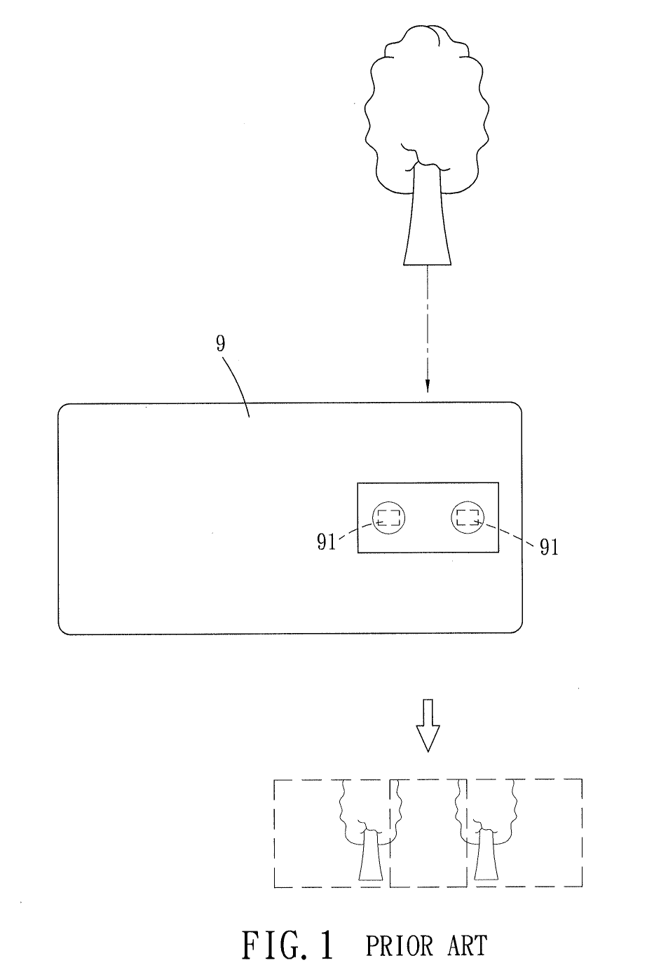

FIG. 2 is a schematic view illustrating another use state of the conventional electronic apparatus of FIG. 1;

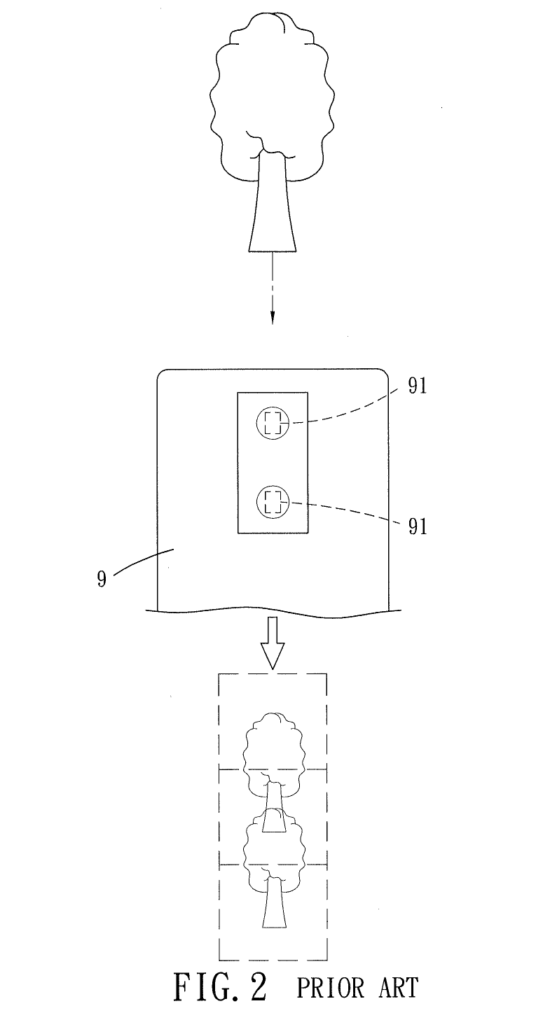

FIG. 3 is a schematic view illustrating a first embodiment of an electronic apparatus having a three dimensional image capturing device according to the present invention;

FIG. 4 is a partial exploded perspective view of the first embodiment;

FIG. 5 is a fragmentary schematic top view of the first embodiment with lens modules in a first position;

FIG. 6 is a view similar to FIG. 5, but with the lens modules in a second position;

FIG. 7 is a schematic view illustrating a use state of the first embodiment when the lens modules are in the second position; and

FIG. 8 is a partial exploded perspective view illustrating a second embodiment of the electronic apparatus having a three dimensional image capturing device according to the present invention.

### DETAILED DESCRIPTION OF THE PREFERRED EMBODIMENTS

The abovementioned and other technical contents, features, and effects of this invention will be clearly presented from the following detailed description of two embodiments in coordination with the reference drawings.

Before this invention is described in detail, it should be noted that, in the following description, similar elements are designated by the same reference numerals.

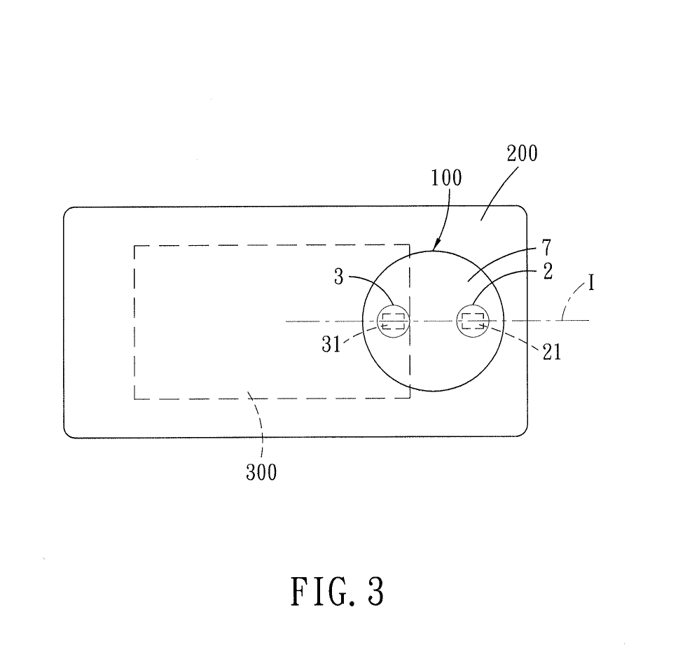

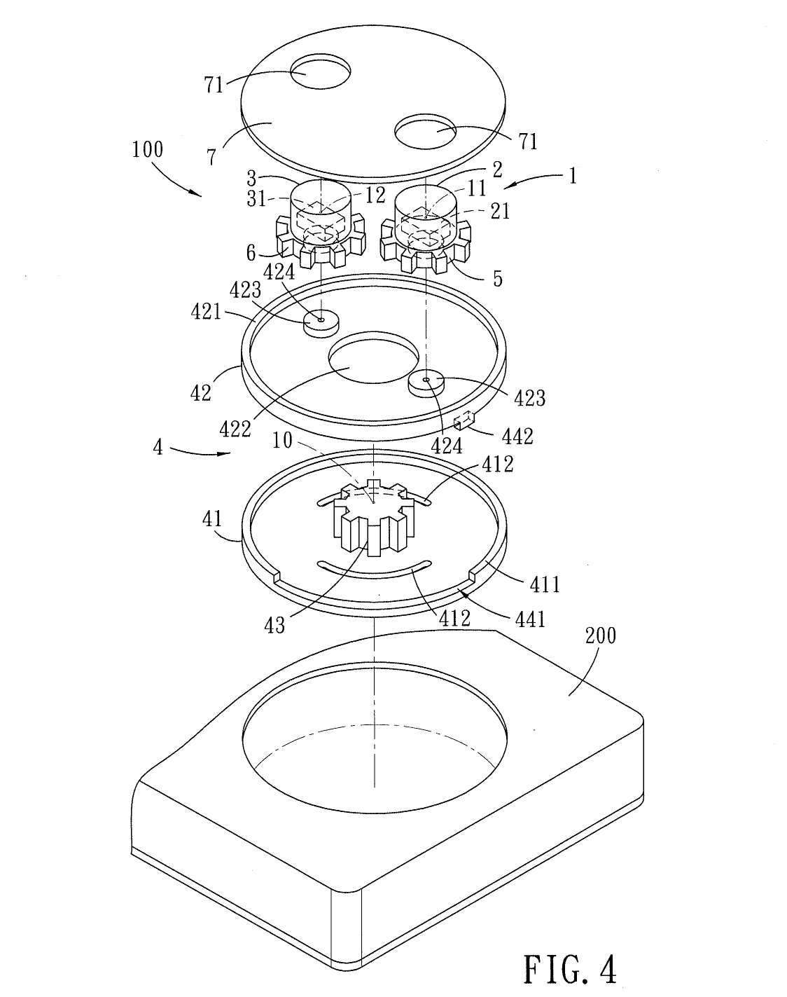

Referring to FIGS. 3 and 4, a first embodiment of an electronic apparatus according to the present invention comprises a housing 200, a rectangular display screen 300 and a three dimensional (3D) image capturing device 100. The electronic apparatus may be a portable device, such as a mobile phone, a digital camera, a digital video camera, or a tablet computer, or any electronic apparatus that requires capturing of static or dynamic images. In this embodiment, the display screen 300 and the 3D image capturing device 100 are respectively mounted to two opposite sides of the housing 200, and are both electrically connected to a circuit board (not shown) in the housing 200, so that an image captured by the 3D image capturing device 100 is displayed on the display screen 300.

The 3D image capturing device 100 includes a driving module 1, a first lens module 2, a second lens module 3, and a cover 7.

The driving module 1 includes a main carrier 4, a first lens carrier 5 and a second lens carrier 6. At least a part of the main carrier 4 is rotatable about a main axis 10. The first lens carrier 5 and the second lens carrier 6 are disposed on the main carrier 4 spaced apart from each other and rotate along with the same.

That is, the first and second lens carriers 5, 6 rotate about the main axis 10 along with the main carrier 4. The first lens carrier 5 rotates about a first axis 11, and the second lens carrier 6 rotates about a second axis 12. The first axis 11, the main axis 10 and the second axis 12 are parallel to each other and are arranged side by side at an interval along a straight line (I). Further, the main axis 10 is located between the first and second axes 11, 12.

The first lens module 2 includes a sensor 21, and is disposed on the first lens carrier 5 and rotates with the same. That is, the first lens module 2 rotates about the first axis 11 along with the first lens carrier 5, and rotates about the main axis 10 along with the main carrier 4. The second lens module 3 includes a sensor 31, and is disposed on the second lens carrier 6 and rotates with the same. That is, the second lens module 3 rotates about the second axis 12 along with the second lens carrier 6, and rotates about the main axis 10 along with the main carrier 4. Each of the sensors 21, 31 may be a charge coupled device (CCD) or a complementary metal oxide semiconductor (CMOS) for capturing a rectangular image. As shown in FIGS. 3 and 4, length and width directions of the rectangular sensors 21, 31 correspond to those of the captured images.

In particular, the main carrier 4 includes a fixed disk 41, a rotatable disk 42, and a gear shaft 43 disposed on the fixed disk 41. The gear shaft 43 has an axis coinciding with the main axis 10. That is, the axis of the gear shaft 43 is also the main axis 10. The fixed disk 41 has a first surrounding wall 411, and the rotatable disk 42 has a second surrounding wall 421 cooperating with the first surrounding wall 411. The rotatable disk 42 is superposed on the fixed disk 41 in such a manner that the second surrounding wall 421 and the first surrounding wall 411 are superimposed one on top of the other or nested one over the other, and is rotatable about the main axis 10 relative to the fixed disk 41. The rotatable disk 42 has a through hole 422. The gear shaft 43 extends through the through hole 422 to protrude out of the rotatable disk 42. Further, the rotatable disk 42 also has two shafts 423 respectively located at two opposite sides of the through hole 422. Axes of the two shafts 423 respectively coincide with the first axis 11 and the second axis 12. That is, the first and second axes 11, 12 are respectively the axes of the two shafts 423. In this embodiment, the first and second lens carriers 5, 6 are respectively a gear, are respectively and rotatably mounted on the shafts 423, and are meshed with the gear shaft 43. Moreover, each of the shafts 423 has a central aperture 424 extending through the rotatable disk 42 along an axis thereof, and the fixed disk 41 further has two arc-shaped through slots 412 respectively corresponding to traces of movement of the central apertures 424 of the shafts 423 when rotating along with the rotatable disk 42. Through this, wires that are respectively and electrically connected to the first and second lens modules 2, 3 may extend through the central apertures 424 of the respective shafts 423 and the respective through slots 412 to electrically connect with the circuit board (not shown) in the housing 200. In this embodiment, the fixed disk 41 and the housing 200 of the electronic apparatus are fabricated separately and then assembled, but the fixed disk 41 may also be formed integrally as one piece with the housing 200.

Further, the main carrier 4 also includes a limiting mechanism disposed on the fixed disk 41 and the rotatable disk 42. In this embodiment, the limiting mechanism includes a limiting notch 441 formed in the first surrounding wall 411 and a limiting protrusion 442 connected to the second surrounding wall 421. The limiting protrusion 442 is movable within the limiting notch 441, and cooperates with the same to limit an angle of rotation of the rotatable disk 42. In this embodiment, the limiting mechanism limits the angle of rotation of the rotatable disk 42 to 90°. The cover 7 is covered on the rotatable disk 42 and rotates along with the same. The cover 7 has two through holes 71 respectively corresponding to the first and second lens modules 2, 3 to expose the same. Each through hole 71 is closed by a transparent plate (not shown) to protect a respective one of the first and second lens modules 2, 3 from being damaged by foreign objects.

Rotation method of the first lens module 2 and the second lens module 3 is described below.

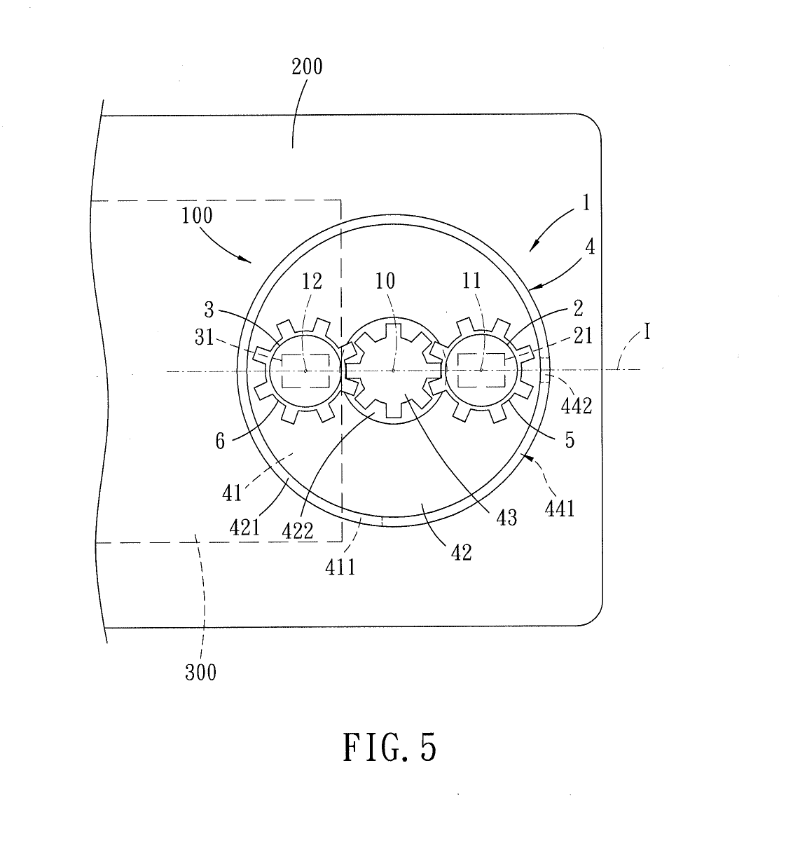

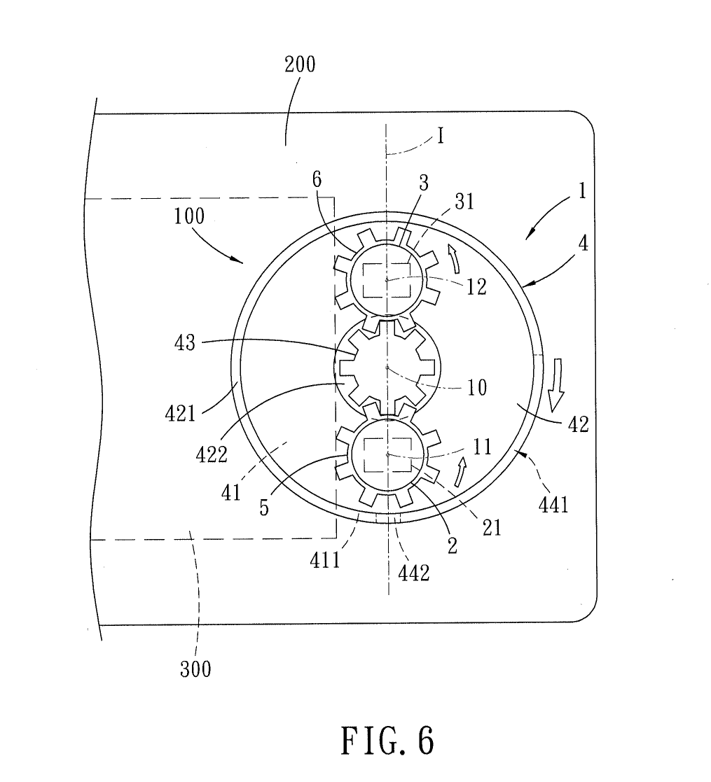

Referring to FIGS. 5 and 6, the first lens module 2 and the second lens module 3 are driven by the driving module 1 to rotate from a first position shown in FIG. 5 to a second position shown in FIG. 6, and from the second position back to the first position. As shown in FIG. 5, in the first position, length directions of images captured by the sensors 21, 31 of the first and second lens modules 2, 3 are parallel to the direction in which the first and second lens modules 2, 3 are arranged horizontally in a row along the straight line (I) and parallel to a length direction of the display screen 300. As such, the electronic apparatus can be oriented horizontally to capture a horizontal three dimensional image, and the length and width directions of the captured image can be displayed on the corresponding length and width directions of the display screen 300, thereby facilitating viewing by the user. In this case, use of the electronic apparatus of the present invention is similar to that of the existing conventional electronic apparatus which is capable of capturing three dimensional images.

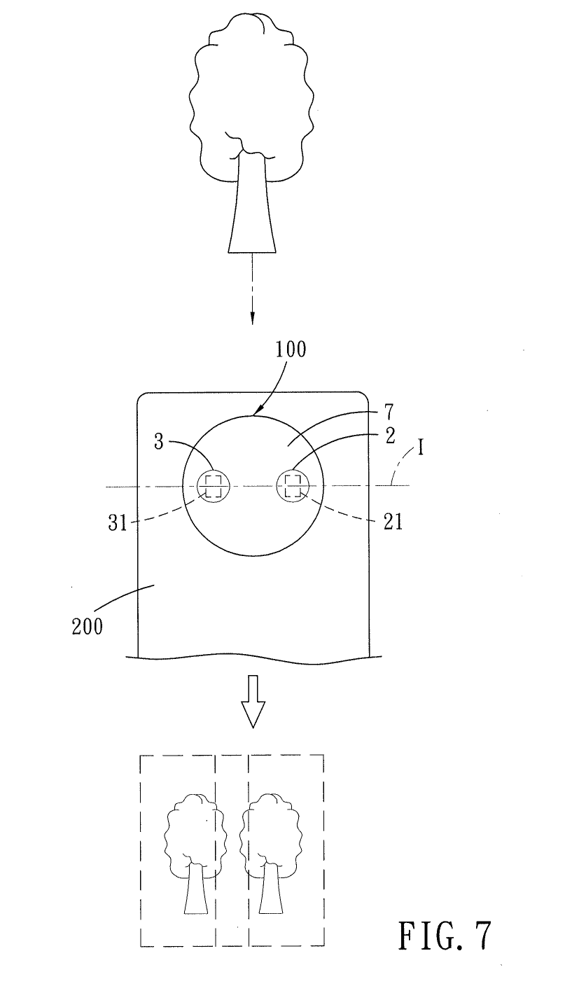

When it is desired to capture an image of a thin and tall object, the rotatable disk 42 is rotated to drive the first and second lens modules 2, 3 to rotate to the second position. When the first and second lens modules 2, 3 are rotated from the first position to the second position, as shown in FIG. 6, the first and second lens carriers 5, 6 synchronously self-rotate by an angle of 90°, rotate about the main axis 10 by an angle of 90°, and are positioned thereat by the limiting mechanism. Because the first and second lens modules 2, 3 rotate respectively with the first and second lens carriers 5, 6, length directions of images captured by the sensors 21, 31 are perpendicular to the direction in which the first and second lens modules 2, 3 are arranged vertically in a row along the straight line (I), but are still parallel to the length direction of the display screen 300. Referring to FIG. 7, the electronic apparatus of the present invention is rotated by an angle of 90° to a vertical orientation from a horizontal orientation shown in FIG. 6, so that the first and second lens modules 2, 3 are arranged in the horizontal direction. In this way, the images captured by the sensors 21, 31 are laterally superimposed in the vertical direction. Hence, a vertical three dimensional image of the whole thin, tall object can be captured. At this time, the length direction of the display screen 300 and the length direction of the captured image are parallel, so that the length and width directions of the image may be displayed on the corresponding length and width directions of the display screen 300, thereby facilitating viewing by the user. Alternatively, the laterally superimposed vertical 3D image may be stored, and if required, may be played back on the display screen 300 or transmitted to other electronic apparatuses for playback.

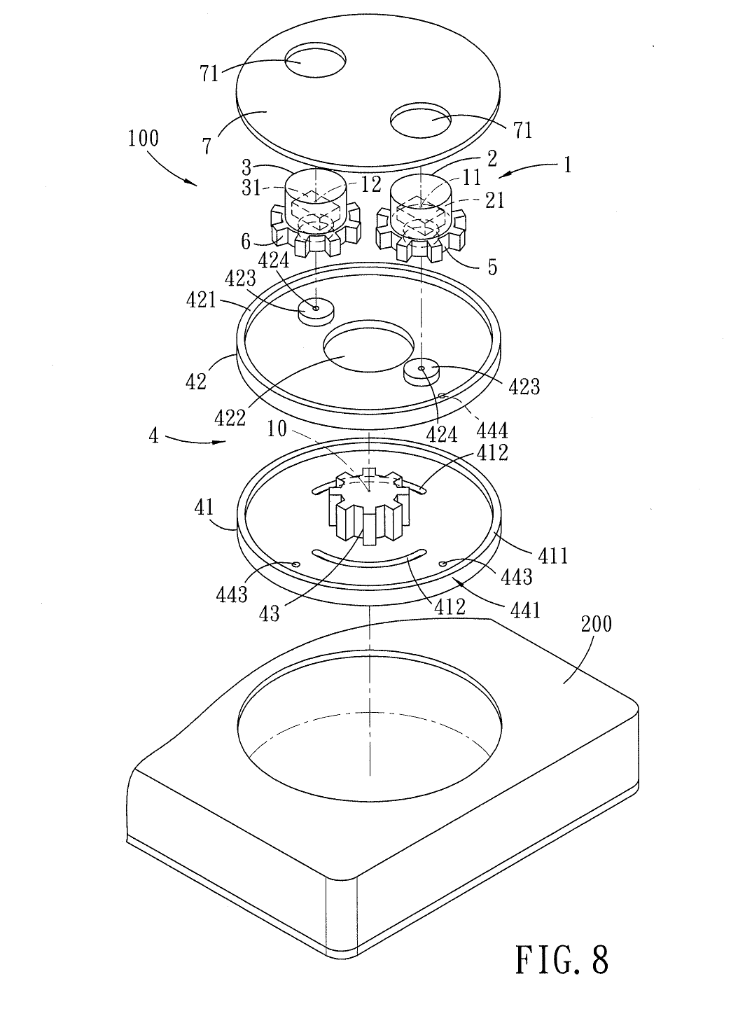

Referring to FIG. 8, a second embodiment of the electronic apparatus according to the present invention is shown to be similar to the first embodiment. However, the limiting mechanism of the three dimensional image capturing device 100 in the second embodiment is different from that in the first embodiment. The limiting mechanism in the second embodiment includes two first magnetic elements 443 disposed on the fixed disk 41, and a second magnetic element 444 disposed on the rotatable disk 42. The two first magnetic elements 443 respectively define two endpoints of the range of rotation of the rotatable disk 42, and are located in a trace of movement of the second magnetic element 444 along with the rotatable disk 42, so that the second magnetic element 444 can be magnetically drawn to one of the first magnetic elements 443. In the second embodiment, the first magnetic elements 443 form an angle of 90° with respect to the main axis 10, and the second magnetic element 444 is movable between the two first magnetic elements 443 to limit the range of rotation of the rotatable disk 42 to 90°. That is, the first magnetic elements 443 and the second magnetic element 444 are spaced apart from the main axis 10 by the same distance, and the first magnetic elements 443 are located on the same circumference centered at the main axis 10 and are spaced apart at an angle of 90°. The second magnetic element 444 is located above the first magnetic elements 443 and is magnetically drawn to one of the first magnetic elements 443. When the second magnetic element 444 moves from one of the first magnetic elements 443 to the other first magnetic element 443, the rotatable disk 42 is rotated by an angle of 90°. Thus, the first magnetic elements 443 and the second magnetic element 444 cooperate with each other to limit the angle of rotation of the rotatable disk 42.

Further, in the above-mentioned two embodiments, the driving module 1 drives the rotatable disk 42 to rotate relative to the fixed disk 41 so that the first and second lens carriers or gears 5, 6 can mesh with the gear shaft 43 and rotate relative to the same. As a result, the first lens module 2 and the second lens module 3 can rotate synchronously and respectively with the gears 5, 6. In an alternate embodiment, the rotatable disk 42 and the fixed disk 41 may be integrated into one piece, in which case a motor is used to drive the gear shaft 43 to directly rotate the two gears 5, 6, so that the first lens module 2 and the second lens module 3 may rotate synchronously and respectively therewith. However, it should be appreciated by those of ordinary skill in the art that the driving module 1 may adopt other suitable manual or electrical methods. As long as the first lens module 2 and the second lens module 3 can be rotated synchronously, any driving method is acceptable.

To sum up, the first lens module 2 and the second lens module 3 of the above-mentioned embodiments may be rotated to the first position to form a horizontal 3D image or rotated to the second position to form a vertical 3D image, so that the user can conveniently capture images of objects with different aspect ratios. Thus, the objects of the present invention can be achieved.

While the present invention has been described in connection with what are considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A three dimensional image capturing device with dual lenses, comprising:
a first lens module including a sensor;
a second lens module spaced apart from said first lens module by a predetermined distance and including a sensor, said first and second lens modules being arranged in a row; and
a driving module capable of driving said first and second lens modules to move between a first position and a second position;
wherein, in said first position, length directions of images captured by said sensors of said first and second lens modules are parallel to said row of said first and second lens modules, and in said second position, length directions of images captured by said sensors of said first and second lens modules are perpendicular to said row of said first and second lens modules.

2. The three dimensional image capturing device of claim 1, wherein said driving module includes:
a first lens carrier defining a first axis, said first lens carrier and said first lens module being connected to each other and rotating together about said first axis;
a second lens carrier defining a second axis, said second lens carrier and said second lens module being connected to each other and rotating together about said second axis; and
a main carrier having a main axis;
wherein said first axis, said main axis and said second axis are parallel to each other and are arranged side by side at an interval along a straight line, said main axis being located between said first and second axes, said first and second lens carriers being disposed on said main carrier and rotating about said main axis along with said main carrier.

3. The three dimensional image capturing device of claim 2, wherein said main carrier includes a fixed disk and a rotatable disk, said rotatable disk being connected movably to said fixed disk and being rotatable about said main axis relative to said fixed disk, said first and second lens carriers being disposed on said rotatable disk.

4. The three dimensional image capturing device of claim 3, wherein said main carrier further includes a gear shaft disposed on said fixed disk, said gear shaft having an axis coinciding with said main axis, said rotatable disk being provided with a through hole, said gear shaft extending through said through hole to protrude out of said rotatable disk.

5. The three dimensional image capturing device of claim 4, wherein said rotatable disk further has two shafts respectively located at two opposite sides of said through hole, axes of said two shafts respectively coinciding with said first and second axes, said first and second lens carriers being respectively a gear, being respectively and rotatably mounted on said shafts, and being meshed with said gear shaft, so that said first and second lens carriers are rotatable relative to said gear shaft.

6. The three dimensional image capturing device of claim 3, wherein said main carrier further includes a limiting mechanism disposed on said fixed disk and said rotatable disk to limit an angle of rotation of said rotatable disk.

7. The three dimensional image capturing device of claim 6, wherein said fixed disk has a first surrounding wall and said rotatable disk has a second surrounding wall cooperating with said first surrounding wall, said limiting mechanism including a limiting notch formed in said first surrounding wall and a limiting protrusion connected to said second surrounding wall, said limiting protrusion being movable within said limiting notch.

8. The three dimensional image capturing device of claim 6, wherein said limiting mechanism includes two first magnetic elements disposed on said fixed disk and a second magnetic element disposed on said rotatable disk, said two first magnetic elements respectively defining two endpoints of a range of rotation of said rotatable disk, and being located in a trace of movement of said second magnetic element along with said rotatable disk, so that said second magnetic element is magnetically drawn to one of said first magnetic elements.

9. The three dimensional image capturing device of claim 3, further comprising a cover covered on said rotatable disk and rotating along with said rotatable disk, said cover having two through holes respectively corresponding to said first and second lens modules.

10. The three dimensional image capturing device of claim 5, wherein each of said shafts has a central aperture extending along an axis thereof, said fixed disk further having two arc-shaped through slots respectively corresponding to traces of movement of said central apertures of said shafts when rotating along with said rotatable disk.

11. An electronic apparatus capable of capturing three dimensional images, comprising:
a housing;
a display screen mounted to said housing; and
a three dimensional image capturing device mounted to said housing and electrically connected to said display screen, said three dimensional image capturing device including
a first lens module including a sensor,
a second lens module spaced apart from said first lens module by a predetermined distance and including a sensor, said first and second lens modules being arranged in a row, and
a driving module capable of driving said first and second lens modules to move between a first position and a second position,
wherein, in said first position, length directions of images captured by said sensors of said first and second lens modules are parallel to said row of said first and second lens modules, and in said second position, length directions of images captured by said sensors of said first and second lens modules are perpendicular to said row of said first and second lens modules.

12. The electronic apparatus of claim 11, wherein said display screen is rectangular, and said driving module includes
a first lens carrier defining a first axis, said first lens carrier and said first lens module being connected to each other and rotating together about said first axis,
a second lens carrier defining a second axis, said second lens carrier and said second lens module being connected to each other and rotating together about said second axis, and
a main carrier having a main axis,
wherein said first axis, said main axis and said second axis are parallel to each other and are arranged side by side at an interval along a straight line, said main axis being located between said first and second axes, said first and second lens carriers being disposed on said main carrier and rotating about said main axis along with said main carrier.

13. The electronic apparatus of claim 12, wherein said main carrier includes a fixed disk and a rotatable disk, said rotatable disk being connected movably to said fixed disk and being rotatable about said main axis relative to said fixed disk, said first and second lens carriers being disposed on said rotatable disk.

14. The electronic apparatus of claim 13, wherein said main carrier further includes a gear shaft disposed on said fixed disk, said gear shaft having an axis coinciding with said main axis, said rotatable disk being provided with a through hole, said gear shaft extending through said through hole to protrude out of said rotatable disk.

15. The electronic apparatus of claim 14, wherein said rotatable disk further has two shafts respectively located at two opposite sides of said through hole, axes of said two shafts respectively coinciding with said first and second axes, said first and second lens carriers being respectively a gear, being respectively and rotatably mounted on said shafts, and being meshed with said gear shaft, so that said first and second lens carriers are rotatable relative to said gear shaft.

16. The electronic apparatus of claim 13, wherein said main carrier further includes a limiting mechanism disposed on said fixed disk and said rotatable disk to limit an angle of rotation of said rotatable disk.

17. The electronic apparatus of claim 16, wherein said fixed disk has a first surrounding wall and said rotatable disk has a second surrounding wall cooperating with said first surrounding wall, said limiting mechanism including a limiting notch formed in said first surrounding wall and a limiting protrusion connected to said second surrounding wall, said limiting protrusion being movable within said limiting notch.

18. The electronic apparatus of claim 16, wherein said limiting mechanism includes two first magnetic elements disposed on said fixed disk and a second magnetic element disposed on said rotatable disk, said two first magnetic elements respectively defining two endpoints of a range of rotation of said rotatable disk, and being located in a trace of movement of said second magnetic element along with said rotatable disk, so that said second magnetic element is magnetically drawn to one of said first magnetic elements.

19. The electronic apparatus of claim 13, further comprising a cover covered on said rotatable disk and rotating along with said rotatable disk, said cover having two through holes respectively corresponding to said first and second lens modules.

20. The electronic apparatus of claim 15, wherein each of said shafts has a central aperture extending along an axis thereof, said fixed disk further having two arc-shaped through slots respectively corresponding to traces of movement of said central apertures of said shafts when rotating along with said rotatable disk.
